(19) United States
(12) Patent Application Publication
(10) Pub. No.: US 2006/0197880 A1
(43) Pub. Date: Sep. 7, 2006

(54) Signal processing device and stream processing method

(76) Inventors: Eiichiro Tomonaga, Tokyo (JP); Masahiro Yamada, Nishitama-gun (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/366,424

(22) Filed: Mar. 3, 2006

(30) Foreign Application Priority Data
Mar. 4, 2005 (JP) 2005-061433

(51) Int. Cl. H04N 5/46

(52) U.S. Cl. 348/729

(57) ABSTRACT

According to one embodiment, a reproduction control unit receives a time stamped stream TTS via a network. A TTS processing unit generates a real time stream TS from the TTS on the basis of the time stamp added to each packet of packets in the TTS. A decode unit decodes the TTS, and outputs video data and audio data in real time. A demultiplexer has a buffer which temporarily records the TTS provided from the reproduction control unit, and provides the TTS recorded in the buffer to the TTS processing unit and provides the same to the decode unit. As a result, the stream received from the network is transmitted and recorded to an external device in real time, and at the same time, the stream is reproduced in real time by a display device or the like.

### CROSS-REFERENCE TO RELATED APPLICATIONS

This application is based upon and claims the benefit of priority from Japanese Patent Application No. 2005-061433, filed Mar. 4, 2005, the entire contents of which are incorporated herein by reference.

### BACKGROUND

1. Field

One embodiment of the invention relates to a signal processing device such as a digital broadcast receiver, and a stream processing method for use in the same.

2. Description of the Related Art

In recent years, there has been developed a real-time transmission system for transmitting in real time a data stream such as a stream containing digital compressed and encoded audio video data. In such a real-time transmission system, the data streams is transmitted by use of a transport stream. The transport stream is configured of transport stream packets.

Further, in recent years, there has been developed a system that transmits packets to each of which time information is added. For example, in Jpn. Pat. Appln. KOKAI Publication No. 2000-341234, a data transmission device that transmits send data to which a count value of a counter has been added is disclosed.

In digital broadcast such as terrestrial digital broadcast as well, broadcast program data is composed of the aforementioned transport stream.

In a digital broadcast receiver, broadcasting signals are received and demodulated by a tuner, thereby a transport stream is extracted from the broadcasting signals. Transport stream packets that configure the transport stream are sent to a decoder in the digital broadcast receiver in real time, and decoded therein. Generally, the decoder is so design that the decode action speed thereof is regulated according to the reception timing of each packet. Since each packet of the transport stream packets is sent to the decoder in real time at a timing corresponding to a reproduction timing thereof, the decoder can decode and reproduce the transport stream correctly.

Meanwhile, in recent years, it has been desired to realize a home network system wherein a plurality of household electric devices can be connected mutually. In a digital broadcast receiver for use in the home network system, there are required functions of decoding and reproducing not only a transport stream that is transmitted in real time like broadcast program data, but also a transport stream that is transmitted at an arbitrary speed via a network from a storage medium.

However, the transport stream read from the storage medium is transmitted to the digital broadcast receiver at a higher speed than the original transmission rate of the transport stream. For this reason, if the transport stream transmitted via a network from a storage medium is input to the decoder as they are, there occur nonconformities such as one wherein the transport stream is reproduced at an abnormally high speed and the like. Accordingly, it is necessary to perform a special decode control to change over the operation control methods for the decoder in accordance with a type of a stream to be decoded (real time stream/non real time stream).

In the digital broadcast receiver for use in the home network system, there is requested the function of recording a transport stream received via a network into an external device such as a digital VCR (Video Cassette Recorder) according to, for example, the IEEE1394 specifications. In this case, it is necessary to transmit the transport stream in real time to the external device.

Furthermore, in recording data to the external device, it is desired to display recorded images for confirming the recorded data and the like.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing a system configuration of a signal processing device according to a first embodiment of the present invention;

FIG. 2 shows an example of a configuration of a time stamped transport stream packet to be used in the signal processing device of the first embodiment;

FIG. 3 is a block diagram showing a configuration of a demultiplexer 106 provided in the signal processing device of the first embodiment;

FIG. 4 is a block diagram showing a configuration of a TTS processing unit provided in the signal processing device of the first embodiment;

FIG. 5 is a block diagram showing a configuration of a record control unit provided in the signal processing device of the first embodiment;

FIG. 6 is a view for explaining the relation between a transport stream packet and synchronous signals for use in the signal processing device of the first embodiment;

FIG. 7 is a flow chart for explaining an operation executed by the signal processing device of the first embodiment; and

FIG. 8 is a block diagram showing a system configuration of a signal processing device according to a second embodiment of the present invention.

### DETAILED DESCRIPTION

Various embodiments according to the invention will be described hereinafter with reference to the accompanying drawings. In general, according to one embodiment of the invention, there is provided a signal processing device comprising: a receiving unit which receives via a network a stream including compressed and encoded data, that is, a time stamped stream TTS configured of packets to each of which a time stamp is added, and provides the time stamped stream TTS; a real time stream generating unit which generates a real time stream from the time stamped stream on the basis of the time stamp added to each packet of the packets in the time stamped stream; a decoder which decodes the time stamped stream, and outputs video data and audio data in real time; and a demultiplexer having a buffer which temporarily records the time stamped stream provided from the receiving unit, the demultiplexer providing the time stamped stream recorded in the buffer to the real time stream generating unit, and providing the same to the decoder.

According to the present invention, it is possible to provide a signal processing device and a stream processing method that can transmit and record a stream received from a network to an external device in real time, and can reproduce the stream by a display device or the like at the same time.

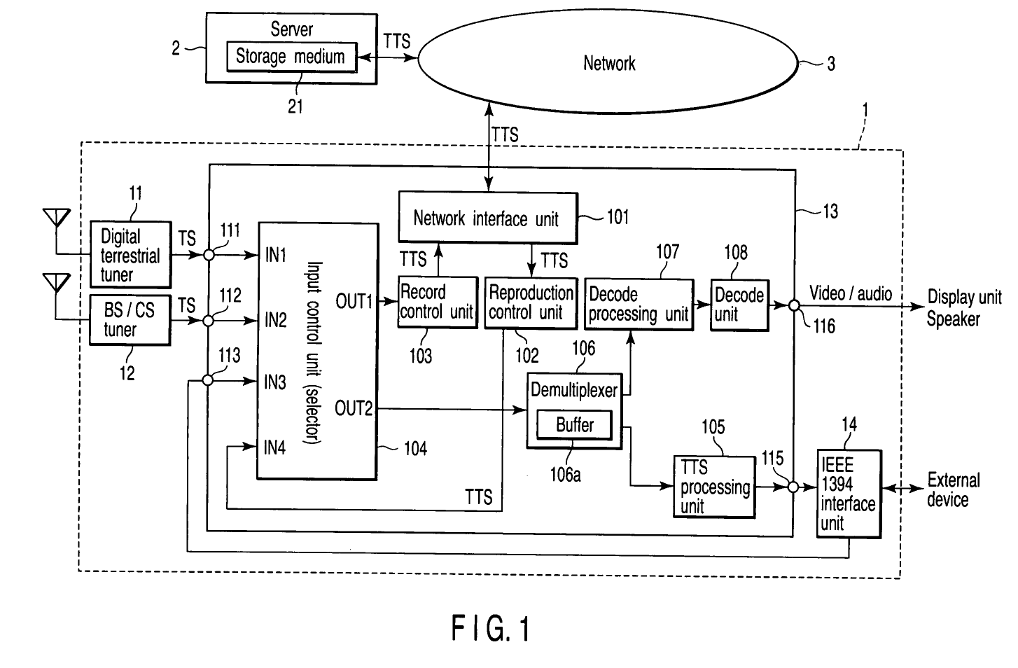

FIG. 1 is a block diagram showing a system configuration of a signal processing device according to a first embodiment of the present invention. The signal processing device is embodied as a digital broadcast receiver for receiving digital broadcast signals.

The digital broadcast receiver 1 has a function of accessing a network 3 such as a household local area network (LAN). The digital broadcast receiver 1 can also perform communications with an external device of the IEEE1394 specification.

A server computer 2 is connected to the network 3. In a storage medium 21 of the server computer 2, audio video (AV) contents are stored. The digital broadcast receiver 1 receives the AV contents stored in the storage medium 21 via the network 3, and can decode and reproduce the received AV contents.

As shown in FIG. 1, the digital broadcast receiver 1 is configured of a digital terrestrial tuner 11, a BS/CS (Broadcasting Satellite/Communication Satellite) tuner 12, a signal processing unit 13, and an IEEE1394 interface unit 14, etc.

The digital terrestrial tuner 1 is a broadcast receiving unit for receiving broadcast program data of terrestrial digital broadcast. The broadcast program data of the terrestrial digital broadcast is configured of a transport stream (TS). Transport stream packets (TS packets) that configure the TS are transmitted in real time from a broadcasting station in form of digital broadcast signals. The digital terrestrial tuner 11 receives digital broadcast signals, and takes out a TS corresponding to broadcast program data of a certain channel from the digital broadcast signals. The TS includes compressed and encoded broadcast program data. This TS is a real time stream. The TS packets that configure the TS are sent from the digital terrestrial tuner 11 to the signal processing unit 13 in real time at the same timing as the timing at which they are sent from the broadcasting station.

The BS/CS tuner 12 is a broadcast receiving unit for receiving broadcast program data of BS/CS broadcast. The broadcast program data of the BS/CS broadcast is configured of a TS in the same manner as in the terrestrial digital broadcast. Transport stream packets (TS packets) that configure this TS are transmitted in real time from the broadcasting station in form of digital broadcast signals. The BS/CS tuner 12 receives digital broadcast signals, and takes out a TS corresponding to broadcast program data of a desired channel from the digital broadcast signals. The TS includes compressed and encoded broadcast program data. This TS is a real time stream. The TS packets that configure the TS are sent from the BS/CS tuner 12 to the signal processing unit 13 in real time at the same timing as the timing at which they are sent from the broadcasting station.

The IEEE1394 interface unit 14 is a communication controller that performs communications via an IEEE1394 serial bus with an IEEE1394 external device (for example, a digital VCR). The IEEE1394 interface unit 14 has a function of receiving a T-S of AV contents that are sent from the external device in real time. The IEEE1394 interface unit 14 also has a function of sending out the TS transferred from the signal processing unit 13 in real time, via the IEEE1394 serial bus to the external device in real time.

The signal processing unit 13 is an LSI for processing a TS. The signal processing unit 13 has a function of receiving the AV contents transferred from the storage medium 21 of the server computer 2. The stream of the AV contents stored in the storage medium 21 is a time stamped transport stream (TTS), and is a non real time stream that can be read at an arbitrary speed from the storage medium 13, irrespective of the original transmission rate corresponding to the actual replay speed. At a request from the signal processing unit 13, the TTS of the AV contents stored in the storage medium 21 is transmitted via the network 3 to the digital broadcast receiver 1 at a higher speed than the original transmission rate of the AV contents.

A TTS is configured of TTS packets. Each of the TTS packets is a time stamped TS packet. In response to the request from the digital broadcast receiver 1, the server computer 2 reads out the TTS from the storage medium 21, and transmits the TTS to the digital broadcast receiver 1.

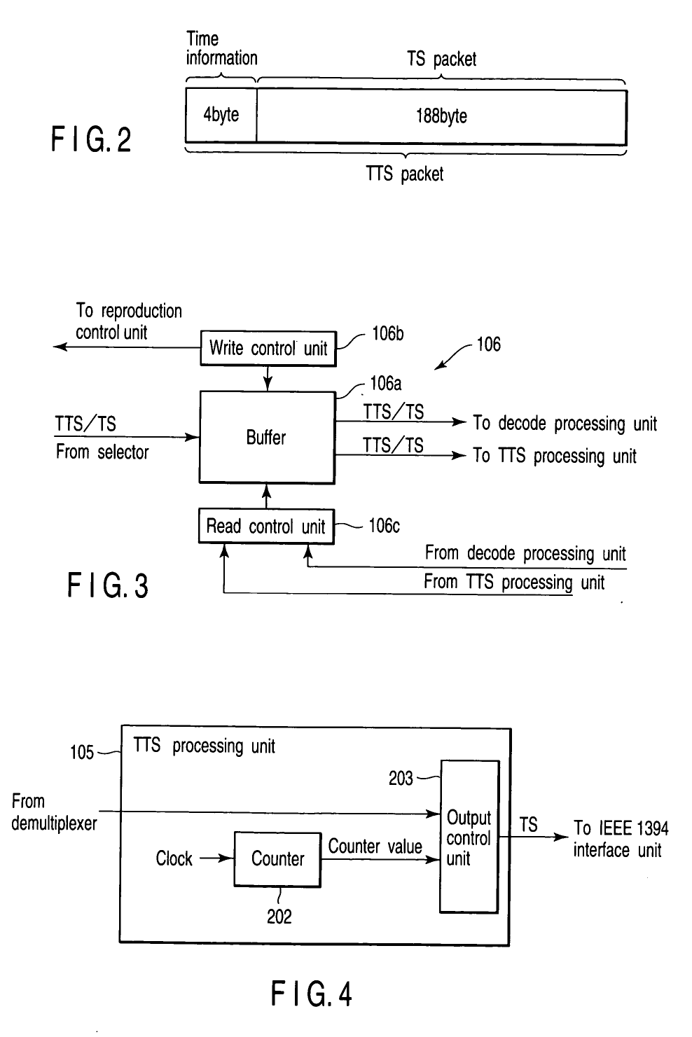

A structure of the TTS packet is shown in FIG. 2. The TTS packet is configured of a 188-byte TS packet, and a 4-byte time stamp (time information) added to the head of the TS packet. The time stamp added to each TS packet is used as time information indicating a relative input time of the TS packet concerned to the decoder.

The signal processing unit 13 includes a network interface unit 101, a reproduction control unit 102, a record control unit 103, an input control unit (selector) 104, a TTS processing unit 105, a demultiplexer (Demux) 106, a decode processing unit 107 and a decode unit 108, etc.

The network interface unit 101 is connected to the network 3 via a LAN port, etc. provided in the digital broadcast receiver 1. The network interface unit 101 is a communication controller that performs communications with the server computer 2 via the network 3.

The reproduction control unit 102 communicates with the server computer 2 via the network interface unit 101, and controls the reproduction (herein reading) of the AV contents recorded in the storage medium 21. The TTS of the AV contents transmitted from the server computer 2 via the network 3 is received by the network interface unit 101, and supplied to the input control unit (selector) 104 via the reproduction control unit 102.

The selector 104 includes input ports IN1 to IN3 for inputting a real time stream respectively, an input port IN4 for inputting the TTS, an output port OUT1 for outputting the real time stream, and an output port OUT2 for outputting the real time stream or the TTS.

The input ports IN1, IN2 of the selector 104 are connected to input terminals 111, 112 of the signal processing unit 13, respectively. The TS received by the digital terrestrial tuner 11 is input via the input terminal 111 to the input port IN1 of the selector 104. Further, the TS received by the BS/CS tuner 12 is input via the input terminal 112 to the input port IN2 of the selector 104. The TS from the external device received by the IEEE1394 interface unit 14 is input via the input terminal 113 to the input port IN3 of the selector 104.

The selector 104 selects a TS to be recorded to the storage medium 21 from the TSs input to the input ports IN1 to IN3, respectively, and outputs the selected TS from the output port OUT1. The TS output from the output port OUT1 is sent to the record control unit 103.

Further, the selector 104 selects a stream to be reproduced or recorded from the TSs or TTSs input to the input ports IN1 to IN4, respectively, and outputs the selected stream from the output port OUT2. The stream output from the output port OUT2 is sent to the demultiplexer (Demux) 106.

The record control unit 103 adds a time stamp to each packet of the TS packets included in the input TS, thereby generating a TTS from the input TS. This TTS is transmitted via the network interface unit 101 to the server computer 2 on the network 3.

The demultiplexer (Demux) 106 provides the stream (TS or TTS) input from the selector 104 to the decode processing unit 107 and the TTS processing unit 105.

When the stream input from the selector 104 is a TTS and the TTS is to be reproduced, the demultiplexer 106 records the packets of the TTS into a buffer 106a temporarily, and transfers the recorded packets to the decode processing unit 107, in response to a request from the decode processing unit 107.

In addition, when the stream input from the selector 104 is a TTS and the TTS is to be recorded, the demultiplexer 106 records the packets of the TTS into the buffer 106a temporarily, supplies the packets to the decode processing unit 107 as mentioned above, and at the same time, transfers the recorded packets to the TTS processing unit 105 in response to a request from the TTS processing unit 105. The buffer 106a of the demultiplexer 106 is provided for absorbing the difference between a transfer rate of the TTS received from the network 3 and a processing rate of the TTS processing unit 105, and the difference between a transfer rate of the TTS received from the network 3 and a processing rate of the decode unit 108.

Further, when the stream input from the selector 104 is a TS and the TS is to be reproduced, the demultiplexer 106 transfers the packets of the TS to the decode processing unit 107 as they are. When the stream input from the selector 104 is a TS and the TS is to be recorded into the external device, the demultiplexer 106 transfers the packets of the TS as they are to the decode processing unit 107 and the TTS processing unit 105.

When the input stream is a TTS, the TTS processing unit 105 generates a real time stream (TS) from the TTS on the basis of a time stamp of each TTS packet in the TTS. More specifically, the TTS processing unit 105 adjusts a sending timing of the TS packet in each TTS packet in accordance with the time stamp of each TTS packet received. Thereby, the TSS packets are output from the output port of the TTS processing unit 105 in real time. The TS provided from the TTS processing unit 105 is sent to the IEEE1394 interface unit 14 via the output terminal 115. Meanwhile, when the input stream is a TS, the TTS processing unit 105 outputs the TS as they are to the IEEE1394 interface unit 14.

The decode processing unit 107 performs a process of separating the TS or TTS input from the demultiplexer 106 into a video data stream and an audio data stream. This separating process is performed, for example, in unit of packet. When a plurality of broadcast programs are multiplexed into the input TS or TTS, the decode processing unit 107 performs a process of extracting packets corresponding to a broadcast program to be reproduced or recorded from the input stream.

The decode unit 108 has a video decoder and an audio decoder (both not illustrated in the figure), and decodes the video data stream and audio data stream input from the decode processing unit 107. The decode unit 108 decodes an individual packet (TS or TTS packet) on the basis of a value of a clock counter provided in the decode unit 108. The decoding process is performed at a timing independent of the time stamp added to the packet. The video data and audio data decoded by the decode unit 108 are D/A converted and amplified, and then output to a display unit and a speaker, respectively.

In the digital broadcast receiver 1, the TTS transmitted from the network 3 to the reproduction processing unit 102 is transferred via the selector 104 and the demultiplexer 106 to the decode processing unit 107, the decode unit 108, and the TTS processing unit 105. When a TS as a real time stream is output from the TTS processing unit 105, video and audio data corresponding to the TS are output from the decode unit 108. Accordingly, when contents received via the network are to be recorded into the external device, a user can confirm what contents are recorded by the display unit or the like. Namely, the present invention improves the usability of the device.

Next, a configuration of the demultiplexer 106 will be explained with reference to FIG. 3 hereinafter.

The demultiplexer 106 includes the buffer 106a for recording TTS packets temporarily, a write control unit 106b for controlling writing to the buffer 106a, and a read control unit 106c for controlling reading from a storage medium on the network 3. Hereinafter, there is explained an operation at the time when TTS packets are read from the storage medium on the network 3, and the TTS packets are recorded into the external device while being reproduced.

The write control unit 106b requests for data to the reproduction control unit 102 such that the buffer 106a does not overflow or become empty, and writes the TTS packets into the buffer 106a. The read control unit 106c reads out the TTS packets recorded in the buffer 106a according to the data request from the decode processing unit 107, and transfers the TTS packets to the decode processing unit 107. Further, the read control unit 106c reads out the TTS packets recorded in the buffer 106a according to the data request from the TTS processing unit 105, and transfers the TTS packets to the TTS processing unit 105.

Meanwhile, when the input packets are TS packets like the TS packets from the digital terrestrial tuner 11, the demultiplexer 106 transfers the TS packets as they are to the decode processing unit 107 and the TTS processing unit 105 as mentioned previously.

Next, a configuration of the TTS processing unit 105 will be explained with reference to FIG. 4 hereinafter.

As shown in FIG. 4, the TTS processing unit 105 is configured of a counter 202 and an output control unit 203, etc. The counter 202 performs a count operation in synchronization with clock signals from a clock generator provided in the signal processing unit 13. The output control unit 203 receives a TTS packet, and when a value of the time stamp of the TTS packet becomes identical to the count value of the counter 202, the output control unit 203 outputs the TS packet in the TTS packet concerned. Thereby, the TS packets are transferred to the IEEE1394 interface unit 14 in real time. It is noted that, when the input packets are TS packets, the TTS processing unit 105 transfers the TS packets as they are to the IEEE1394 interface unit 14.

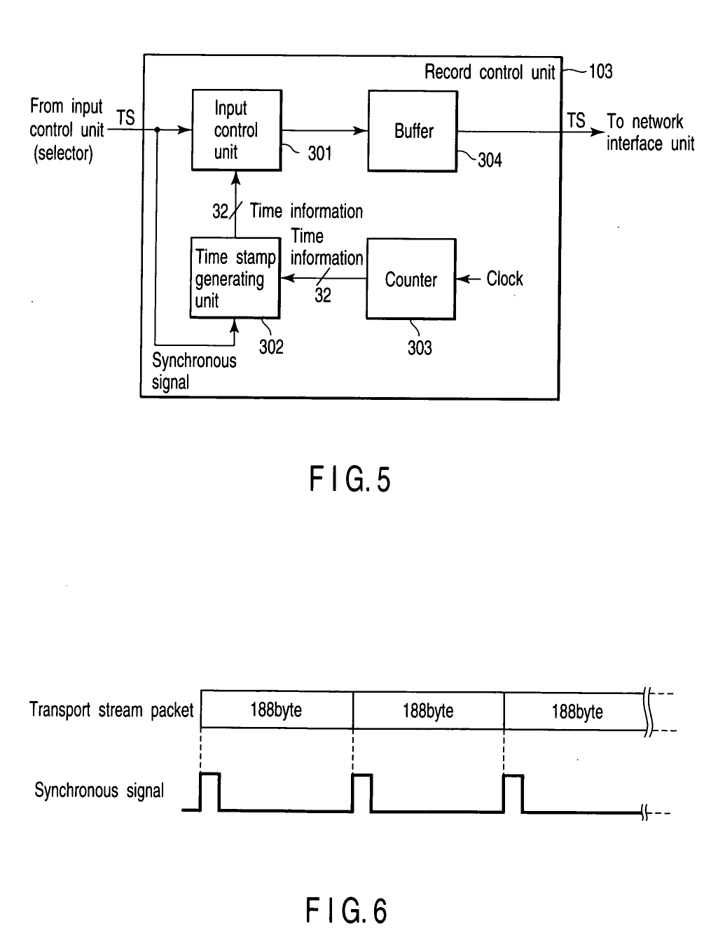

Next, a configuration of the record control unit 103 will be explained with reference to FIG. 5 hereinafter.

The record control unit 103 is configured of an input control unit 301, a time stamp generating unit 302, a counter 303, and a buffer 304, etc. The record control unit 103 receives a TS output from the selector 104. This TS is composed of TS packets and synchronous signals as shown in FIG. 6. The synchronous signals show separators between TS packets. The TS packets are input to the input control unit 301, and the synchronous signals are input to the time stamp generating unit 302.

The counter 303 performs a count operation in synchronization with the aforementioned clock signals, and outputs a 32-bit counter value as time information. On receiving a rise edge of the synchronous signal, the time stamp generating unit 302 outputs the 32-bit counter value (time information) at that moment to the input control unit 301.

The input control unit 301 adds the 32-bit counter value (time information) from the time stamp generating unit 302 to the head of the received TS packet, and thereby generates a TTS packet. Each generated TTS packet is sent via the buffer 304 to the network interface unit 101.

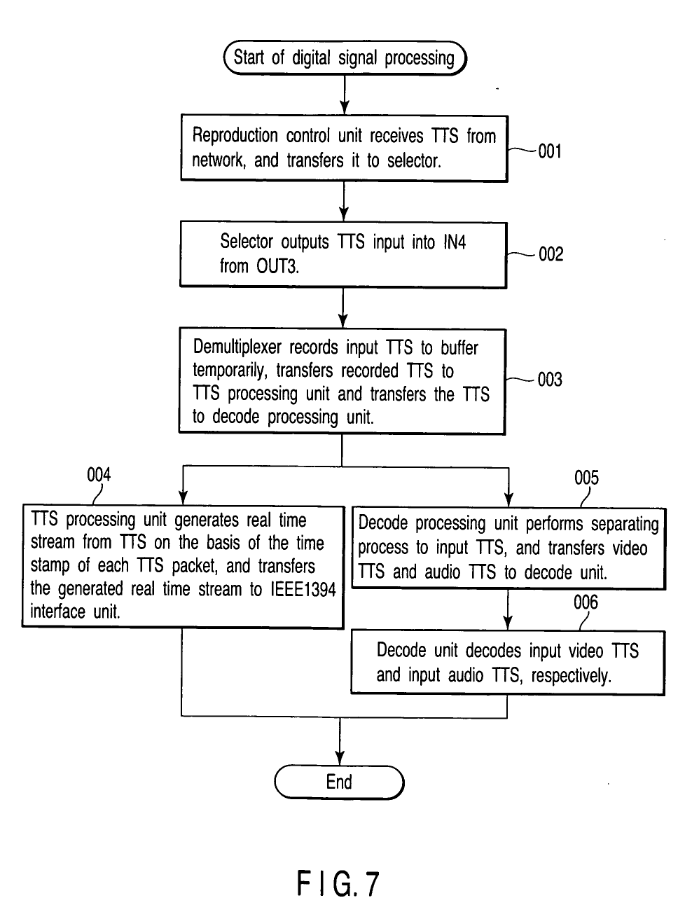

Next, with reference to the flow chart in FIG. 7, an operation of reproducing the stream received from the network 3 and at the same time, transmitting the stream to the external device in real time will be explained hereinafter.

The reproduction control unit 102 receives a TTS transmitted from the server computer 2 via the network interface unit 101 and the network 3 (block 001). The received TTS is sent to the selector 104. The selector 104 outputs the TTS input into the input port IN4 from the OUT3 (block 002). While buffering the input TTS, the demultiplexer 106 transfers the TTS to the TTS processing unit 105 and transfers the TTS to the decode processing unit 107 (block 003).

The TTS processing unit 105 generates a real time stream from the received TTS on the basis of the time stamp of each TTS packet. The generated real time stream is sent to the IEEE1394 interface unit 14 (block 004). This real time stream is a TS.

The decode processing unit 107 performs a separating process on the input TTS, and sends a video TTS and an audio TTS to the decode unit 108 via different routes (block 005). The decode unit 108 decodes the input video TTS and audio TTS, respectively (block 006).

Next, a second embodiment of the present invention will be explained hereinafter.

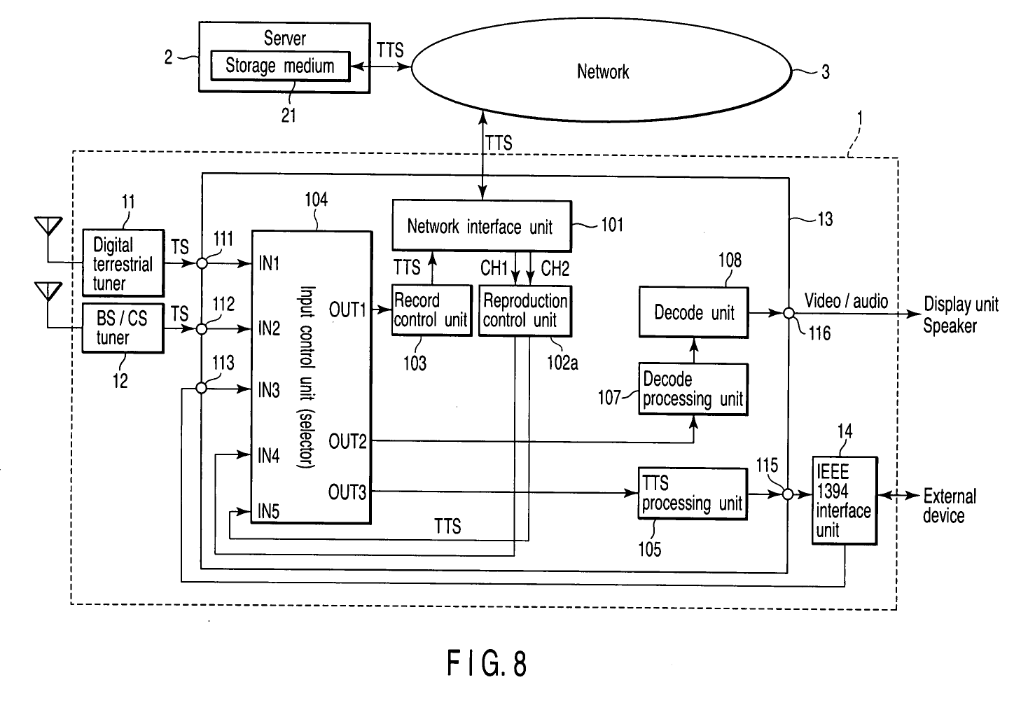

FIG. 8 is a block diagram showing a configuration of a digital broadcast receiver 1 according to the second embodiment. In the figure, the same functional components as those in the first embodiment are denoted by the same reference numerals, and the detailed description thereof is omitted.

In this embodiment, when contents are read from the storage medium 21 on the network 3, and are recorded into an external device, a reproduction control unit 102a reads out identical contents via two communication channels CH1, CH2 in the network 3, and outputs the contents separately from two output ports. More specifically, the network interface unit 101 receives TTSs of identical contents from the storage medium 21 on the network 3 in a time sharing manner, and transfers the TTSs via mutually different signal lines to the reproduction control unit 102a.

A TTS transferred via the channel CH1 is output from the reproduction control unit 102a to an input port IN4 of a selector 104a, and a TTS transferred via the channel CH2 is output from the reproduction control unit 102a to an input port IN5 of the selector 104a.

The selector 104a outputs the TTS input to the input port IN4 from the output port OUT2, and outputs the TTS input to the input port IN5 from the output port OUT3. The output port OUT2 is connected to the decode processing unit 107, and the output port OUT3 is connected to the TTS processing unit 105.

The decode processing unit 107 performs a process of separating the input TTS into a video TTS and an audio TTS. The decode unit 108 decodes the input video TTS and audio TTS, respectively, and the decoded video data and audio data are output via an output terminal 116 to a display device and a speaker, respectively.

The TTS processing unit 105 generates a real time stream (TS) from the input TTS on the basis of the time stamp of each input TTS packet. The generated real time stream is transferred via the IEEE1394 interface unit 14 to an external device.

As explained above, according to the digital broadcast receiver of the second embodiment, identical contents (TTSs) are input via mutually different communication channels on a network. One content is converted into a real time stream by the TTS processing unit 105, and sent via the IEEE1394 interface unit 14 to the external device. The other content is sent via the decode processing unit 107 to the decode unit 108 and decoded therein, and supplied to the display unit and the speaker. Accordingly, there is no need to provide a buffer 106a for absorbing the difference between a transfer rate of the TTS on the network 3 and a processing rate of the TTS processing unit 105, and the difference between a transfer rate of the TTS on the network 3 and a processing rate of the decode unit 108 as explained in the first embodiment.

As explained heretofore, according to the present invention, it is possible to, while transmitting and recording a stream received from the network 3 to the external device in real time, reproduce recorded contents in real time, and confirm the details thereof.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A signal processing device comprising:
a receiving unit which receives via a network a stream including compressed and encoded data, that is, a time stamped stream configured of packets to each of which a time stamp is added, and provides the time stamped stream;
a real time stream generating unit which generates a real time stream from the time stamped stream on the basis of the time stamp added to each packet of the packets in the time stamped stream;
a decoder which decodes the time stamped stream, and outputs video data and audio data in real time; and
a demultiplexer having a buffer which temporarily records the time stamped stream provided from the receiving unit, the demultiplexer providing the time stamped stream recorded in the buffer to the real time stream generating unit, and providing the same to the decoder.

2. A signal processing device according to claim 1, further comprising:
a broadcast receiving unit which receives digital broadcast, and provides a real time stream of a selected broadcast program; and
a selector having: a first input port to which the real time stream provided from the broadcast receiving unit is input; a second input port to which the time stamped stream provided from the receiving unit is input, and an output port from which the one selected stream among the real time stream and the time stamped stream received by the first and second input ports is output to the demultiplexer.

3. A signal processing device according to claim 1, further comprising:
a real time stream interface unit which transfers the real time stream generated by the real time stream generating unit to an external device, and receives a real time stream from the external device.

4. A signal processing device according to claim 2, further comprising:
a real time stream interface unit which transfers the real time stream generated by the real time stream generating unit to an external device, and receives a second real time stream from the external device, wherein the selector comprises a third input port to which the second real time stream is input from the external device provided from the real time stream interface unit, and a second output port from which the real time stream input to the selected input port among the first and third input ports is output;
a time stamp adding unit which adds a time stamp to each packet of the packets included in the real time stream output from the second output port of the selector; and
a unit which transmits the packets to which time stamps have been added by the time stamp adding unit via the network to the outside.

5. A signal processing device comprising:
a network interface unit which receives contents recorded in a storage medium on a network via the network in the format of a stream including compressed and encoded data, that is, a time stamped stream configured of packets to each of which a time stamp is added, and provides the time stamped stream;
a read control unit which reads out one content recorded in the storage medium on the network via two communication channels in the network by using the network interface unit, and provides the content as the time stamped stream from first and second output units, respectively;
a real time stream generating unit which receives the time stamped stream of the content provided from the read control unit from the first output unit, and generates a real time stream from the time stamped stream on the basis of the time stamp added to each packet of the packets in the received stream; and
a decoder which receives the time stamped stream of the content provided from the read control unit from the second output unit, decodes the received stream, and outputs video data and audio data in real time.

6. A signal processing device according to claim 5, further comprising:
a broadcast receiving unit which receives digital broadcast, and provides a real time stream of a selected broadcast program; and
a selector comprising: a first input port to which the real time stream provided from the broadcast receiving unit is input; second and third input ports to which the time stamped streams provided from the first and second output ports of the read control unit are input, respectively; a first output port from which the stream input to the selected input port among the first to third input ports is output to the real time stream generating unit; and a second output port from which the stream input to the selected input port among the first to third input ports is output to the decoder.

7. A signal processing device according to claim 5, further comprising:
a real time stream interface unit which transfers the real time stream generated by the real time stream generating unit to an external device, and receives a real time stream from the external device.

8. A signal processing device according to claim 6, further comprising:
a real time stream interface unit which transfers the real time stream generated by the real time stream generating unit to an external device, and receives a second real time stream from the external device, wherein the selector has a fourth input port to which the second real time stream from the external device supplied from the real time stream interface unit is input, and a third output port from which the real time stream input to the selected input port among the first and fourth input ports is output; and
a time stamp adding unit which adds a time stamp to each packet of the packets included in the real time stream output from the third output port of the selector, and transfers the packets to a storage medium on the network by using the network interface unit.

9. A stream processing method comprising:
receiving via a network a stream including compressed and encoded data, that is, a time stamped stream configured of packets to each of which a time stamp is added, and providing the time stamped stream;
temporarily recording the time stamped stream to a buffer;
reading out the time stamped stream recorded in the buffer, and generating a real time stream from the time stamped stream on the basis of the time stamp added to each packet of the packets in the time stamped stream; and
reading out the time stamped stream recorded in the buffer, decoding the time stamped stream, and outputting video data and audio data in real time.
